(19) United States
(12) Patent Application Publication
(10) Pub. No.: US 2015/0063785 A1
(43) Pub. Date: Mar. 5, 2015

(54) METHOD OF OVERLAPPINGLY DISPLAYING VISUAL OBJECT ON VIDEO, STORAGE MEDIUM, AND ELECTRONIC DEVICE

(71) Applicant: Samsung Electronics Co., Ltd., Gyeonggi-do (KR)

(72) Inventors: Ho-Young LEE, Seoul (KR); Gyu-Chual KIM, Gyeonggi-do (KR)

(73) Assignee: Samsung Electronics Co., Ltd.

(21) Appl. No.: 14/308,115

(22) Filed: Jun. 18, 2014

(30) Foreign Application Priority Data
Aug. 28, 2013 (KR) 10-2013-0102563

(51) Int. Cl. G11B 27/036

(52) U.S. Cl. CPC G11B 27/036
USPC 386/280

(57) ABSTRACT

A method and electronic device of overlappingly displaying a visual object on a video are provided. The method includes setting a visual effect area at one part of the video; applying a visual effect to the visual effect area; and displaying a visual object such that the visual object overlaps the visual effect area to which the visual effect has been applied.

### PRIORITY

This application claims priority under 35 U.S.C. §119(a) to Korean Application Serial No. 10-2013-0102563, which was filed in the Korean Intellectual Property Office on Aug. 28, 2013, the entire content of which is incorporated herein by reference.

### BACKGROUND

1. Field of the Invention

The present invention relates generally to a method of displaying video.

2. Description of the Related Art

An electronic device includes a display unit, and the user can control the electronic device through an input device while viewing various operation states of the corresponding electronic device and application states through the display unit. Particularly, an electronic device, such as a mobile phone and the like, manufactured to be carried by the user typically does not include four direction buttons for up, down, left, and right movements due to its limited size and generally adopts a method of providing a user interface through a display unit enabling a screen touch input by the user.

As electronic devices, such as a smart phone, a tablet and the like, become more popular, demands for providing or receiving video contents through the use of the electronic device have increased. For example, the user can view videos of various services through the electronic device and a service provider also can provide or advertise information through the videos.

When a user views a video through an electronic device, content informing the user of message reception or an advertisement content by the demand of a video service provider is sometimes displayed while overlapping the video. In such a condition, it is often difficult to distinguish the content from the video. Even when a visual effect is provided to identify the content, the video may not be normally reproduced due to the limited resources of the portable electronic device, such as a smart phone, and the user may be inconvenienced in viewing the video because of an excessive visual effect.

### SUMMARY

The present invention has been made to at least partially resolve, alleviate, or remove at least one of the problems and/or disadvantages associated with the related art, and to provide at least the advantages described below.

In accordance with an aspect of the present invention, a method of overlappingly displaying a visual object on a video is provided. The method includes setting a visual effect area at one part of the video; applying a visual effect to the visual effect area; and displaying a visual object such that the visual object overlaps the visual effect area to which the visual effect has been applied.

In accordance with another aspect of the present disclosure, an electronic device is provided. The electronic device includes a display unit that displays a video; and a controller that sets a visual effect area at one part of the video, applies a visual effect to the visual effect area through the display unit, and displays a visual object such that the visual object overlaps the visual effect area to which the visual effect has been applied.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a block diagram of an electronic device according to an embodiment of the present invention;

FIG. 2 is a flowchart illustrating a method of overlappingly displaying a visual object on a video according to an embodiment of the present invention;

FIGS. 3A to 4B are screen views illustrating a relation between a position of a visual object and a position of a visual effect area;

FIGS. 5A to 6B are screen views illustrating a method of overlappingly displaying a visual object on a video according to another embodiment of the present invention;

FIGS. 7A to 7C are screen views illustrating a method of overlappingly displaying a visual object on a video according to another embodiment of the present invention;

FIGS. 8A to 8C are screen views illustrating a method of overlappingly displaying a visual object on a video according to another embodiment of the present invention;

FIGS. 9A to 9C are screen views illustrating a method of overlappingly displaying a visual object on a video according to another embodiment of the present disclosure;

FIGS. 10A and 10B are screen views illustrating a method of overlappingly displaying a visual object on a video according to another embodiment of the present invention;

FIGS. 11A to 11C are screen views illustrating a method of overlappingly displaying a visual object on a video according to another embodiment of the present invention;

FIGS. 12A to 12C are screen views illustrating a method of overlappingly displaying a visual object on a video according to another embodiment of the present invention; and

FIGS. 13A to 13C are screen views illustrating a method of overlappingly displaying a visual object on a video according to another embodiment of the present invention.

### DETAILED DESCRIPTION OF EMBODIMENTS OF THE PRESENT INVENTION

Various embodiments will now be described more fully with reference to the accompanying drawings in which some embodiments are shown. Therefore, it should be understood that there is no intent to limit the embodiments to the particular forms disclosed, but on the contrary, it is intended that the embodiments are to cover all modifications, equivalents, and alternatives falling within the scope of the invention.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present invention. As used herein, the term “and/or” includes any and all combinations of one or more of the associated listed items.

The terms used in this application are for the purpose of describing particular embodiments only and is not intended to be limiting. As used herein, the singular forms are intended to include the plural forms as well, unless the context clearly indicates otherwise. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification. Such terms as those defined in a generally used dictionary are to be interpreted to have the meanings equal to the contextual meanings in the relevant field of art, and are not to be interpreted to have ideal or excessively formal meanings unless clearly defined in the present specification.

In the present invention, an electronic device may be referred to as a terminal, a portable terminal, a mobile terminal, a communication terminal, a portable communication terminal, a portable mobile terminal, a display device or the like.

For example, the electronic device may be a smart phone, a mobile phone, a navigation device, a game machine, a TeleVision (TV), a notebook computer, a laptop computer, a tablet computer, a Personal Media Player (PMP), a Personal Digital Assistant (PDA) or the like. The electronic device may be implemented as a portable communication terminal of a pocket size having a wireless communication function. Further, the electronic device may be a flexible device or a flexible display device.

The electronic device may communicate with an external electronic device, such as a server or the like, or perform an operation through an interworking with the external electronic device. For example, the electronic device may transmit an image photographed by a camera and/or position information detected by a sensor unit to the server through the network. The network may be a mobile or cellular communication network, a Local Area Network (LAN), a Wireless Local Area Network (WLAN), a Wide Area Network (WAN), an Internet, a Small Area Network (SAN) or the like, but is not limited thereto.

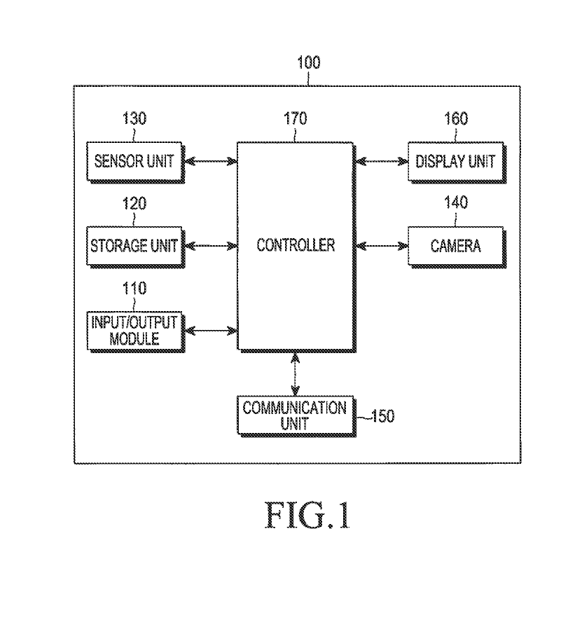

FIG. 1 illustrates a block diagram of an electronic device according to an embodiment of the present disclosure. While FIG. 1 shows a representative configuration of the electronic device, some components may be omitted or changed as necessary.

The electronic device 100 may include an input/output module 110, a storage unit 120, a sensor unit 130, a camera 140, a communication unit 150, a display unit 160, and a controller 170.

The input/output module 110 is a means for receiving a user input or informing the user of information and may include a plurality of buttons, a microphone, a speaker, a vibration motor, a connector, a keypad, a mouse, a trackball, a joystick, cursor direction keys, or a cursor control.

The buttons may be formed on a front surface, a side surface, and/or a rear surface of the electronic device 100, and may include a power/lock button, a volume button, a menu button, a home button, a back button, or a search button.

The microphone receives a voice or sound and generates an electrical signal according to a control of the controller 170.

The speaker may output sounds corresponding to various signals (for example, a wireless signal, a broadcasting signal, a digital audio file, a digital video file or photographing) to the outside of the electronic device 100 according to a control of the controller 170. The speaker may output a sound corresponding to a function performed by the electronic device 100. One or more speakers may be provided.

The vibration motor may convert an electrical signal into a mechanical vibration according to a control of the controller 170. For example, when the electronic device 100 in a vibration mode receives a voice call from another device, the vibration motor is operated. One or more vibration motors may be provided. The vibration motor may operate in response to a touch action of the user touching the display unit 160 or successive motions of the touch on the display unit 160.

The connector provides an interface for connecting the electronic device 100 with a server, an external electronic device, or a power source. According to a control of the controller 170, data stored in the storage unit 120 of the electronic device 100 may be transmitted to an external device or received from an external device through a wired cable connected to the connector. Power may be input from a power source through the wired cable connected to the connector or a battery may be charged.

The keypad receives a key input from the user to control the electronic device 100, and may include a physical keypad formed on the electronic device 100 or a virtual keypad displayed on the display unit 160.

The storage unit 120 stores data for driving one or more of a voice recognition application, a schedule management application, a document making application, a music application, an Internet application, a map application, a camera application, an e-mail application, an image editing application, a search application, a file search application, a video application, a game application, a Social Network Service (SNS) application, a phone application, and a message application. The storage unit 120 stores images for providing a Graphical User Interface (GUI) related to one or more applications, user information, data or database such as a document, background images (menu screen, idle screen or the like) or operating programs required for driving the electronic device 100, and images photographed by a camera. The storage unit 120 is a machine (for example, computer)-readable medium. The term “machine-readable medium” may be defined as a medium providing data to the machine to perform a specific function. The machine-readable medium may be a storage medium. The storage unit 120 may include a non-volatile medium and a volatile medium. All of these media should be a tangible type that allows the commands transferred by the media to be detected by a physical instrument of the machine reading the commands.

The machine-readable medium includes a floppy disk, a flexible disk, a hard disk, a magnetic tape, a Compact Disc Read-Only Memory (CD-ROM), an optical disk, a punch card, a paper tape, a Random Access Memory (RAM), a Programmable Read-Only Memory (PROM), an Erasable PROM (EPROM), and a flash-EPROM, but is not limited thereto.

The sensor unit 130 may include one or more sensors that detect a state (position, direction, motion or the like) of the electronic device 100. For example, the sensor unit 130 may include a proximity sensor that detects whether the user approaches to the electronic device 100 or a motion/direction sensor that detects the operation of the electronic device 100 (for example, rotation acceleration, retardation, or vibration of the electronic device 100). Further, the motion/direction sensor may include an acceleration sensor (or gravity sensor) that detects a change in linear speed, a gyro sensor that detects angular speed, an impact sensor, a Global Positioning System (GPS) sensor, a compass sensor (or a gyro sensor) that detects a direction, an inertia sensor that detects inertial force of motion and provides various information, such as acceleration, speed direction, and distance of a moving object to be measured. The sensor unit 130 may detect a state of the electronic device 100, generate a signal corresponding to the detection, and transmit the generated signal to the controller 170. For example, the GPS sensor may receive radio waves from a plurality of GPS satellites in Earth orbit and calculate a position of the electronic device 100 by using the time of arrival of the radio waves from the GPS satellites to the electronic device 100. The compass sensor may calculate a posture or direction of the electronic device 100.

The camera 140 may include a lens system that forms an optical image of a subject by allowing light incident from the outside to converge, an image sensor that converts the optical image to an electrical image signal or data and outputs the electrical image signal or data, and a driver that drives the image sensor according to a control of the controller 170, and may further include a flash.

The communication unit 150 is provided for a direct connection between the electronic device 100 and a server or external electronic device or a connection through the network, and may be a wired or wireless communication unit. The communication unit 150 transmits data from the controller 170, the storage unit 120, or the camera 140 through a wired cable or wirelessly or receives data from an external communication line or the air through a wired cable or wirelessly to transmit the data to the controller 170 or store the data in the storage unit 120.

The communication unit 150 may include a mobile communication module, a WLAN module, or a LAN module. The communication unit 150 may include an Integrated Services Digital Network (ISDN) card, a modem, a LAN card, an infrared port, a Bluetooth port, a ZigBee port, or a wireless port, but is not limited thereto.

The mobile communication module enables the electronic device 100 to be connected with an external device through mobile communication by using one or more antennas according to a control of the controller 170. The mobile communication module exchanges data, such as a voice call, a video call, a Short Message Service (SMS), a Multimedia Messaging Service (MMS) with a mobile phone, a smart phone, a table Personal Computer (PC), or another device, which has a phone number input into the electronic device 100 or transmits/receives a Radio Frequency (RF) signal for unidirectionally transmitting or receiving the data.

The WLAN module may be connected to the Internet in a place where a wireless AP (Access Point) is installed according to a control of the controller 170. The WLAN module supports a wireless LAN standard (IEEE802.11x) of the Institute of Electrical and Electronics Engineers (IEEE). The LAN module may wirelessly perform short distance communication between the electronic device 100 and an image forming apparatus (not shown) according to a control of the controller 110. A short distance communication scheme may include Bluetooth, Infrared Data Association (IrDA) or the like.

The display unit 160 displays an image or data input from the controller 170 on a screen. As the display unit 160, a Liquid Crystal Display (LCD), a touch screen or the like may be used. The display unit may display an image according to a control of the controller 170 and generate a key contact interrupt when a user input means, such as a finger or a stylus pen, contacts the display unit, and may output user input information including an input coordinate and an input state to the controller 170 according to a control of the controller 170.

The display unit 160 may provide graphical user interfaces corresponding to various services (for example, a call, data transmission, broadcasting and picture/video photographing) to the user. The display unit 160 may transmit user input information corresponding to one or more touches input into the graphical user interface to the controller 170. The display unit 160 may receive one or more touches through a user's body (for example, the user's fingers) or a touchable input means (for example, a stylus pen). Also, the display unit 160 may receive a continuous motion of one touch. The display unit 160 may transmit user input information corresponding to the continuous motion of the input touch to the controller 170.

The touch is not limited to the contact between the display unit 160 and the user's body or the touchable input means, and may include a non-contact hovering input (for example, where a detectable interval between the display unit 190 and the user's body or the touchable input means is larger than 0 cm and less than or equal to 5 cm). The detectable interval may be larger according to a hovering detection capability of the display unit 160. The display unit 160 may be a touch screen in, for example, a resistive type, a capacitive type, an infrared type, an acoustic wave type, an ElectroMagnetic (EM) type, or an ElectroMagnetic Resonance (EMR) type.

The controller 170 executes an application according to user input information and the application performs a program operation according to the user input information. The user input may include an input through the input/output module 110, the display unit 160, or the sensor unit 130, or an input based on the camera 140. The controller 170 may include a bus for information communication and a processor connected with the bus for information processing. The controller 170 may include a Central Processing Unit (CPU), an application processor, a communication processor and/or the like.

The controller 170 may further include a Random Access Memory (RAM) connected with the bus to temporarily store information required by the processor and a Read Only Memory (ROM) connected with the bus to store static information required by the processor.

The controller 170 controls general operations of the electronic device 100 and functions to perform a method of improving visibility of a visual object overlappingly displayed on a video according to the present invention.

The video refers to an image in which an object (for example, person, plant, item, background image, foreground image or the like) within the image moves or a visual attribute (color, brightness, chroma, transparency or the like) of the image is changed. The video may include a plurality image frames (or a plurality of still images) and each of the image frames may include a plurality of pixels. The video may be a digital video file (for example, file having a file extension of mpeg, mpg, mp4, avi, mov, wmv, mkv or the like), a streaming video, a flash file, a video (for example, video displayed at the beginning when an application is executed) provided on an application screen, a video provided on a web page screen or the like.

The visual object may be an image and/or a text. The visual object may be displayed on the display unit 160 of the electronic device 100 and include, for example, a content, a text, a menu, a function item (or menu item), a button, a short-cut icon, a thumbnail image, a folder, a picture, a video, a message, a hyperlink, a key, a button or the like. The visual object may be selected, executed, removed, moved, or changed by a user input means. The function item may indicate an executable function, one function included in a particular menu or the like. The short-cut icon is displayed on the display unit 160 of the electronic device 100 to rapidly execute each application, or a call, a contact number, a menu or the like basically provided to the electronic device 100, and the controller 170 may execute the corresponding application when a command or a selection for executing the short-icon is input.

Various embodiments of the present invention may make a content look better by changing some attributes of the video in a screen displaying both a video and the content corresponding to the visual object. Various embodiments of the present invention may make the content look better or make the content harmonize with the video by grasping in advance a position of the content or visual information to be displayed in the future on a screen reproducing the video and partially changing an attribute value of the video. Various embodiments of the present invention may make an attribute of the video harmonize with an attribute of the content or improve readability by providing a partial filter between the video and the content. Various embodiments of the present invention may apply a differential visual effect of intensively displaying a part requiring reinforcement of the visibility and gently displaying a part which does not require the reinforcement of the visibility through differentiation of the visual effect. Various embodiments of the present invention may transmit new additional information through the visual effect of the video and content or the attribute change.

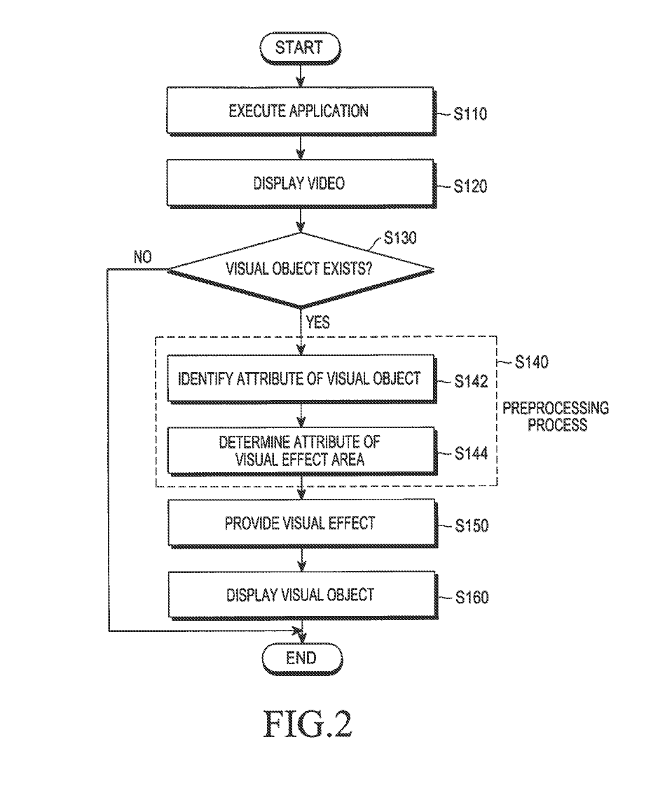

FIG. 2 is a flowchart illustrating a method of overlappingly displaying a visual object on a video according to an embodiment of the present invention.

In step S110 corresponds to an application execution step in which the controller 170 executes an application automatically or according to a user input. An automatically executed application may be a home application, a basic application, an application set to be automatically executed in an environment setup, or an application automatically executed according to the generation of an event such as message reception, call reception, alarm or the like.

In the execution of the application by the user input, the controller 170 may receive the user input through the input/output module 110, the sensor unit 130, the communication unit 150, or the display unit 160. The user may select a button, an icon, or a menu item through the input/output module 110 or the display unit 160, input a voice command through a microphone of the input/output module 110, perform a gesture or motion input through the camera 140, or wirelessly input an execution command of a particular application through the communication unit 150.

The gesture or motion input refers to drawing a trace of a preset pattern, such as a circle, a triangle, or a quadrangle in the air within a viewing angle of the camera 140 or a sensing range of the sensor unit 130 by using a hand or a finger of the user. At this time, the gesture may be also referred to as a space gesture in order to be distinguished from a touch gesture. The touch gesture includes a direct touch on the display unit 160 or a hovering in close proximity to the display unit 160.

In step S120, the controller 170 displays or reproduces a video on the display unit 160. The controller 170 may display an application screen on the display unit 160 and reproduce a video within the application screen. The video may be stored in the storage unit 120 or received from a server through the communication unit 150. For example, the video may be reproduced on a video application screen. Alternatively, the video may be displayed on an entire screen of the display unit 160. For example, when the user selects the video stored in the storage unit 120 or the server in a state where the application screen is displayed, the controller 170 may display the video on the application screen or the entire screen.

In step S130, the controller 170 determines whether there is the visual object to be overlappingly displayed on the video while the video is reproduced. The controller 170 performs step S140 when there is the visual object and ends the method when there is no visual object.

In step S140, the controller 170 performs a preprocessing process for overlappingly displaying the visual object on the video. Steps S130 and S140 may be performed after the application is executed and before the video is displayed. Further, when the application is designed to provide a visual effect by itself, attributes of a visual effect area may be predetermined and stored in the storage unit 120. In this case, steps S130 and S140 may be omitted. Alternatively, when the application is designed to perform the preprocessing process, only step S130 may be omitted among steps S130 and S140.

The preprocessing process includes steps S142 and S144.

In step S142, the controller 170 identifies the one or more attributes of the visual object. The controller 170 may identify some of the various attributes of the visual object (size, position, color, brightness, chroma, shape, transparency, a type of an emphasis effect (change in brightness, clarity, or transparency), an application condition of the emphasis effect, duration time of the emphasis effect or the like). For example, the controller 170 may identify only a size of the visual object, only a position of the visual object, or both the size and the position of the visual object. The shape of the visual object may be a quadrangle, a circle, a triangle, a star or the like, and may be fixed as a preset shape. For example, when the position of the visual object is not variable but is fixed (like subtitles overlappingly displayed on the video), the controller 170 may identify only the size of the visual object. For example, when the size of the visual object is not variable but is fixed, the controller 170 may identify only the position of the visual object.

The position of the visual object may be an absolute position (for example, x and y coordinates based on the origin of the display unit 160, such as a position of a lower left edge of the display unit 160) or a relative position (for example, x and y coordinates based on the origin of the video, such as a position of a lower left edge of the video).

For example, an area and a position of the visual object may be indicated by {x1, y1} corresponding to a position of a lower left edge of the visual object and {x2, y2} corresponding to a position of an upper right edge of the visual object based on the origin of the display unit 160. In another example, the area and the position of the visual object may be indicated by a horizontal length and a vertical length of the visual object and {x1, y1} corresponding to a position of a lower left edge of the visual object.

In step S144, the controller 170 determines the one or more attributes of the visual effect based on the attributes of the visual object and determines some of the various attributes of the visual effect area (size, position, color, brightness, chroma, shape, transparency, a type of visual effect (blur effect, dimming effect, subtrack effect, transparent effect or the like), an application condition of the visual effect, duration time of the visual effect or the like). For example, the controller 170 may determine only the size of the visual effect area, only the position of the visual effect area, or both the size and the position of the visual effect area.

A shape of the visual effect area may be determined according to the shape of the visual object, and the visual effect area may have a similar shape to that of the visual object, the same shape as that of the visual object, or a shape that is expanded from the visual object. The visual effect area may be expanded in a horizontal direction, a vertical direction or a combination thereof. For example, when the visual object is a square having predetermined horizontal and vertical lengths, the visual effect area may be a rectangle having longer a horizontal or vertical length than that of the square or a rectangle having longer horizontal and vertical lengths than those of the square. The shape of the visual effect area may be a quadrangle, a circle, a triangle, a star or the like, and may be fixed as a preset shape. For example, when the visual object is a text, the shape of the visual object may be defined as a quadrangle having a minimum area including the entirety of the text and the size of the visual object may be defined as an area of the quadrangle.

When the position of the visual effect area is not variable but is fixed, the controller 170 may determine only the size of the visual effect area. When the size of the visual effect area is not variable but is fixed, the controller 170 may determine only the position of the visual effect area.

The visual effect area may at least partially or fully overlap the visual object. That is, the visual object may overlap only the visual effect area of the video and may not overlap the remaining area of the video except for the visual effect area. The size of the visual effect area may be larger than the size of the visual object and the center position of the visual effect area may be the same as a center position of the visual object. For example, the visual effect area may be expanded such that contours of the visual effect area are outwardly spaced apart from contours of the visual object by preset pixels (for example, ten pixels horizontally and vertically, respectively).

In step S150 the controller 170 provides the visual effect to the visual effect area of the video. The visual effect is provided to make the visual object more easily distinguishable from the video and is provided to some areas (that is, the visual effect area) of the video. The position of the visual effect area corresponds to the position of the visual object.

For example, the visual effect may be directly applied to the video or may be provided by applying a filter or a preset image for the visual effect to the visual effect area. When the visual effect is directly applied to the video, the video may include image frames to which the visual effect has been applied. That is, although the present embodiment has described such that the visual effect area is set to the video to which the visual effect has not been applied and the visual effect is provided to the set visual effect area, the visual effect may have been already applied to the video itself, and the controller 170 may recognize in real time the visual effect area of the video during the reproduction of the video, or identify information on the visual effect area from the video, an application, or a video/application related file.

Further, the video to which the visual effect has been applied may be stored or the original video to which the visual effect has not been applied may be stored. When the video to which the visual effect has been applied is stored, it may not be required to provide the visual effect to the video in future reproductions of the video.

The visual effect may be implemented by various digital filters. For example, the visual effect may be implemented by a blur filter for blurring some areas of the video, a dim filter for dimming some areas of the video, a subtrack filter for displaying some areas of the video with a complementary color of the visual object, an alpha filter for making some areas of the video transparent, and a chroma filter for processing a preset color to be transparent in some areas of the video. The blur filter provides an effect of making some areas of the video look blurry as if the some areas of the video are rapidly moving.

In step S160, the controller 170 displays the visual object in such a manner that the visual object overlaps the visual effect area to which the visual effect has been applied. At this time, the visual object may be displayed transparently or opaquely. When the visual object is transparent, a part of the visual effect area overlapping the visual object (for example, a center part of the visual effect area) is displayed to overlap the visual object. When the visual object is opaque, a part of the visual effect area overlapping the visual object is not displayed.

Steps S130 to S160 may be repeated until the visual object does not exist while the video is reproduced.

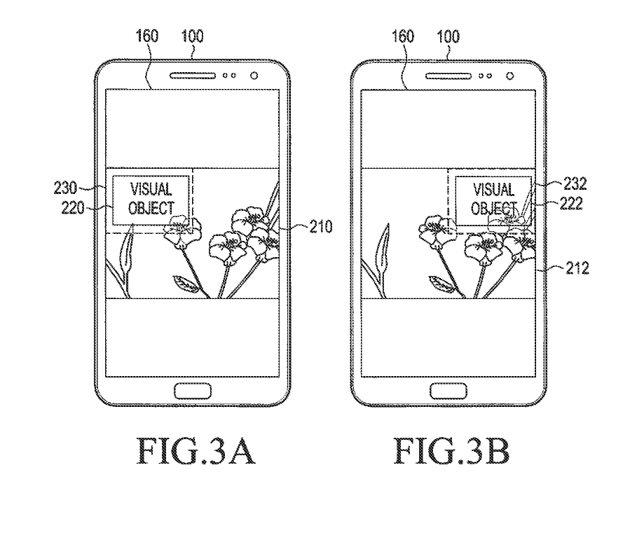

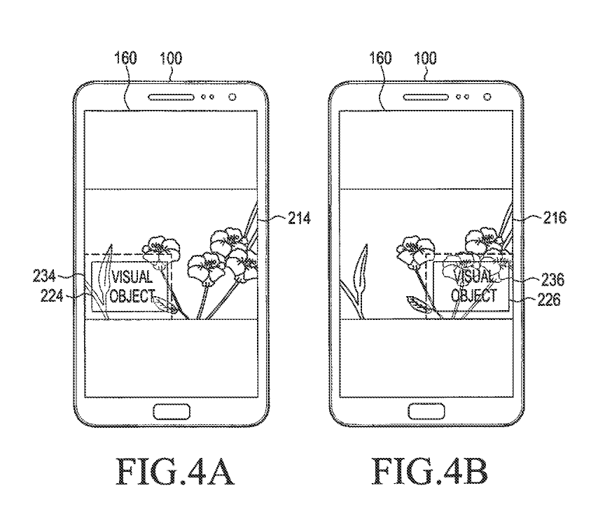

FIGS. 3A to 4B are screen views illustrating a relation between a position of the visual object and a position of the visual effect area.

Referring to FIG. 3A, a video 210 is reproduced, a visual object 220 is overlappingly displayed on an upper left part of the video 210, a visual effect area 230 is set at a position corresponding to the visual object 220, and a blur effect is applied to the visual effect area 230. Through the blur effect, the visual effect area 230 of the video 210 looks blurry and the remaining area of the video 210 looks clear. The visual effect area 230 has a larger area than that of the visual object 220 and the entirety of the visual object 220 is located within the visual effect area 230.

Referring to FIG. 3B, a video 212 is reproduced, a visual object 222 is overlappingly displayed on an upper right part of the video 212, a visual effect area 232 is set at a position corresponding to the visual object 222, and a blur effect is applied to the visual effect area 232.

Referring to FIG. 4A, a video 214 is reproduced, a visual object 224 is overlappingly displayed on a lower left part of the video 214, a visual effect area 234 is set at a position corresponding to the visual object 224, and a blur effect is applied to the visual effect area 234.

Referring to FIG. 4B, a video 216 is reproduced, a visual object 226 is overlappingly displayed on a lower right part of the video 216, a visual effect area 236 is set at a position corresponding to the visual object 226, and a blur effect is applied to the visual effect area 236.

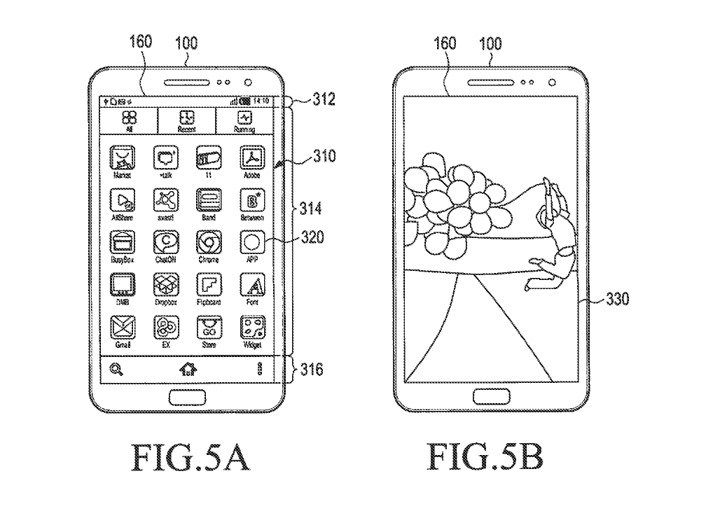

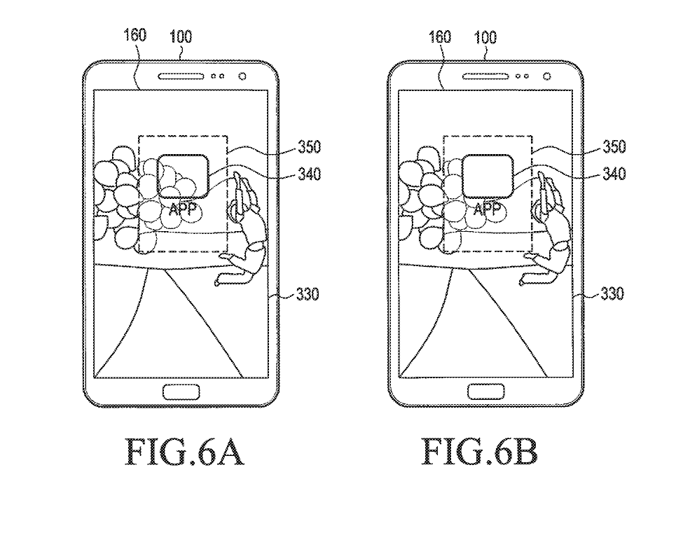

FIGS. 5A to 6B are screen views illustrating a method of overlappingly displaying the visual object on the video according to another embodiment of the present invention where, when an application is executed, a total feeling of the application is conveyed by executing first few seconds of a video.

FIG. 5A illustrates a home screen 310 of display unit 160, which includes a status bar 312 for displaying an application update, an execution state of the LAN module, an intensity of a received signal, and time. The home screen also includes an icon for displaying a list of all applications, an icon for displaying a list of recently used applications, a wallpaper 314 for displaying icons of individual applications, and a menu 316 including a search icon or a home icon.

The controller 170 detects that the user selects an APP icon 320 and executes an application mapped to the APP icon 320.

FIG. 5B illustrates a video 330 reproduced according to an execution of an application.

Referring to FIG. 6A, the video 330 is reproduced, a visual object 340 is overlappingly displayed on a center part of the video 330, a visual effect area 350 is set at a position corresponding to the visual object 340, and a blur effect is applied to the visual effect area 350. Through the blur effect, the visual effect area 350 of the video 330 looks blurry and the remaining area of the video 330 looks clear. The visual effect area 350 has a larger area than that of the visual object 340 and the entirety of the visual object 340 is located within the visual effect area 350.

Further, an emphasis effect using transparency is applied to the visual object 340, and the transparency of the visual object 340 is changed from a high value to a low value over time. The transparency of the visual object 340 is high in FIG. 6A, and the transparency of the visual object 340 is low in FIG. 6B.

It is noted in FIG. 6A that a part of the video overlapping the visual object 340 is overlappingly shown together with the overlaid visual object since the transparency of the visual object 340 is high.

It is noted in FIG. 6B that a part of the video overlapping the visual object 340 is not shown since the transparency of the visual object 340 is low.

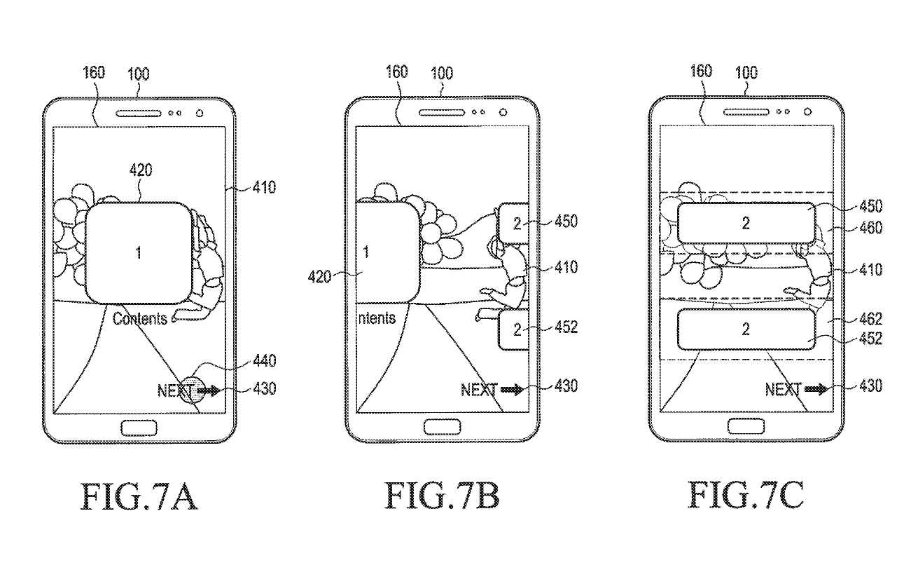

FIGS. 7A to 7C are screen views illustrating a method of overlappingly displaying the visual object on the video according to another embodiment of the present invention, where a visual object such as a button is displayed on the video and the visual effect is applied to the visual object displayed after the user selects the visual object.

Referring to FIG. 7A, a video 410 is reproduced, a first visual object 420 is overlappingly displayed on a center part of the video 410, and a second visual object 430 corresponding to a next button is overlappingly displayed on a lower part of the video 410. The second visual object 430 is an executable object and may be selected by the user.

Referring to FIG. 7B, the controller 170 detects that the user selects the second visual object 430 as indicated by reference number 440 in FIG. 7A and performs screen switching to remove the first visual object 420 and display third and fourth visual objects 450 and 452. In the present embodiment, the controller 170 performs sliding screen switching. Through the sliding screen switching, the first visual object 420 is moved to a left side of the screen and is gradually removed from the screen. The third and fourth visual objects 450 and 452 are moved to a left side from a right side of the screen and are gradually displayed on the screen, as seen in FIG. 7C.

Referring to FIG. 7C, through the screen switching, the third and fourth visual objects 450 and 452 are overlappingly displayed on a center part of the video 410, a first visual effect area 460 is set at a position corresponding to the third visual object 450, and a blur effect is applied to the first visual effect area 460. Similarly, a second visual effect area 462 is set at a position corresponding to the fourth visual object 452 and a blur effect is applied to the second visual effect area 462.

The controller 170 may control levels of the blur effect and further improve visibility of the corresponding visual object by applying more of a transparency effect to each visual effect area. Further, the controller 170 may apply an emphasis effect to each visual object. An emphasis effect may include, but is not limited to, highlighting, making each visual object look three-dimensional, making contours of each visual bold, animating, playing voice clips, changing appearance of each visual object, flashing, blinking, and any other way of making each visual object appealing to the user. When the transparency effect is applied to the visual effect area of the video, another screen overlapping the video (for example, a home screen, another application screen or the like) is overlappingly shown together with the video.

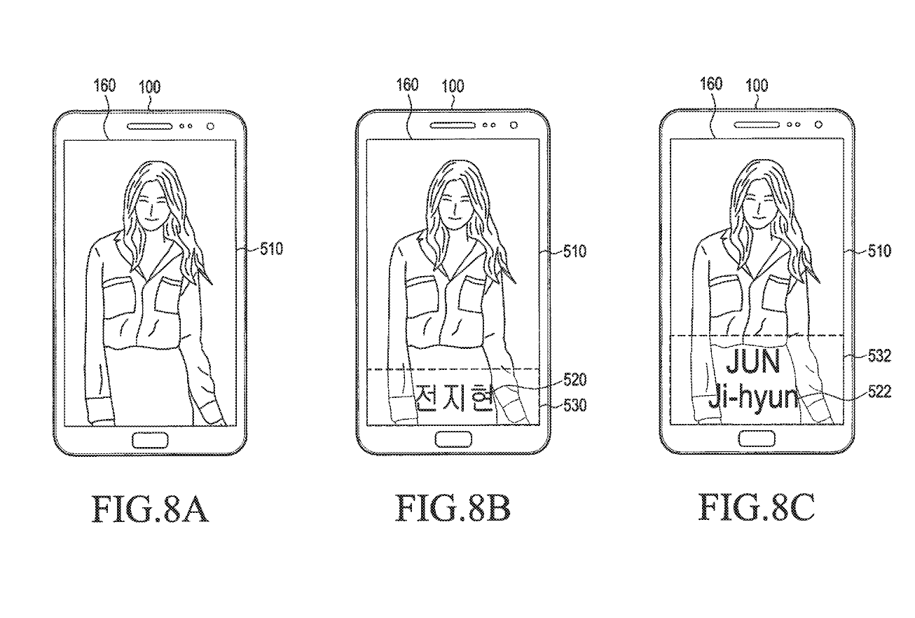

FIGS. 8A to 8C are screen views illustrating a method of overlappingly displaying the visual object on the video according to another embodiment of the present invention, where, when the visual object corresponding to a text such as subtitles is displayed on the video, a size of the visual effect area is changed according to a font size of the text or a text size.

Referring to FIG. 8A, a video 510 is reproduced.

Referring to FIG. 8B, the video 510 is reproduced, a first visual object 520 corresponding to Korean subtitles is overlappingly displayed on a lower part of the video 510 as the video 510 is reproduced, a first visual effect area 530 is set at a position corresponding to the first visual object 520, and a blur effect is applied to the first visual effect area 530.

Referring to FIG. 8C, a second visual object 522 corresponding to English subtitles is overlappingly displayed on a lower part of the video as the video is reproduced, a second visual effect area 532 is set at a position corresponding to the second visual object 522, and a blur effect is applied to the second visual effect area 532.

In a comparison between FIGS. 8B and 8C, the second visual object 522 is larger than the first visual object 520, the first visual effect area 530 having a relatively smaller size is set for the first visual object 520 having a relatively smaller size, and the second visual effect area 532 having a relatively larger size is set for the second visual object 522 having a relatively larger size.

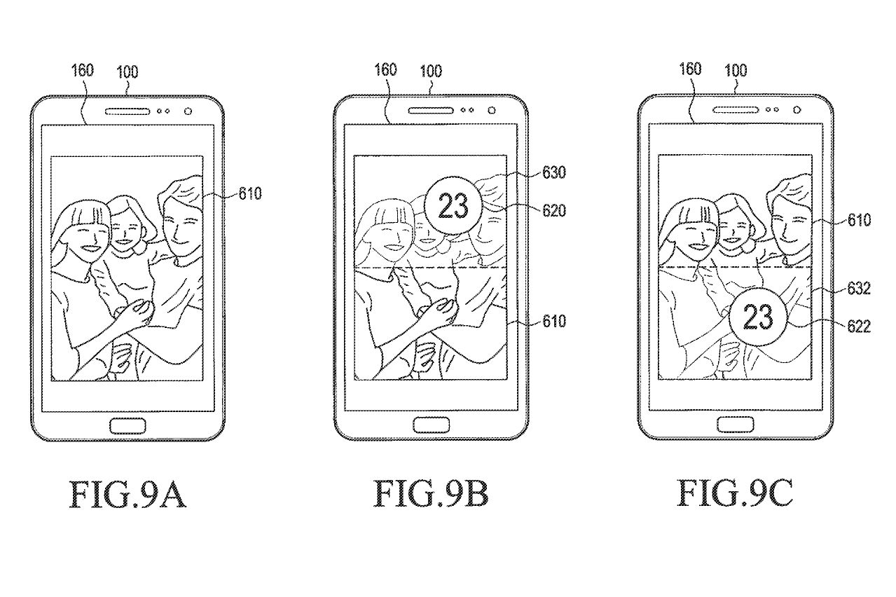

FIGS. 9A to 9C are screen views illustrating a method of overlappingly displaying the visual object on the video according to another embodiment of the present invention, where, when the visual object corresponding to a text is displayed on the video, a position of the visual effect area is changed according to a position of the text.

Referring to FIG. 9A, a video 610 is reproduced.

Referring to FIG. 9B, a first visual object 620 is overlappingly displayed on an upper part of the video 610 in a state where the video 610 is reproduced, a first visual effect area 630 is set at a position corresponding to the first visual object 620, and a blur effect is applied to the first visual effect area 630.

Referring to FIG. 9C, a second visual object 622 is overlappingly displayed on a lower part of the video 610 in a state where the video 610 is reproduced, a second visual effect area 632 is set at a position corresponding to the second visual object 622, and a blur effect is applied to the second visual effect area 632.

In a comparison between FIGS. 9B and 9C, a size of the first visual object 620 is the same as a size of the second visual object 622, the first visual object 620 is displayed on an upper part of the video 610, and the second visual object 622 is displayed on a lower part of the video 610. The first and second visual effect areas 630 and 632 having the same size are set for the first and second visual objects 620 and 622 having the same size, the first visual effect area 630 is located to correspond to a position of the first visual object 620, and the second visual effect area 632 is located to correspond to a position of the second visual object 622.

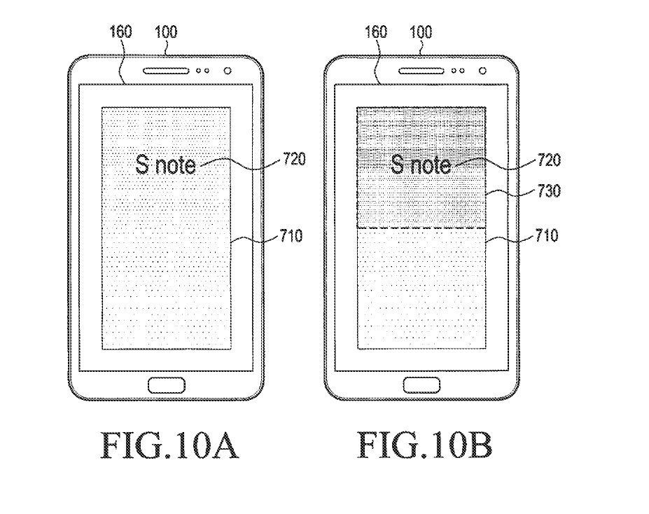

FIGS. 10A and 10B are screen views illustrating a method of overlappingly displaying the visual object on the video according to another embodiment of the present invention, where, when the visual object corresponding to a text is displayed on the video, a color of the visual effect area of the video is changed to be contrasted with a color of the text.

Referring to FIG. 10A, in a state where a video 710 is reproduced, a visual object 720 corresponding to a text “S note” is overlappingly displayed on an upper part of the video 710. Since a color (for example, white) of the visual object 720 is similar to a color (for example, light sky blue) of a part of the video overlapping the visual object 720, it is difficult to distinguish the visual object from the video 710.

Referring to FIG. 10B, a visual object 720 corresponding to a text “S note” is overlappingly displayed on an upper part of the video 710 in a state where the video 710 is reproduced, and a visual effect area 730 is set at a position corresponding to the visual object 720. The controller 170 changes an attribute of the visual effect area 730 to darken a color of the visual effect area 730 being displayed. Since a color (for example, white) of the visual object 720 and the visual effect areas 730 are contrasted with a color (for example, dark sky blue) of a part of the video overlapping the visual object 720 according to the application of the visual effect, the visual object is easily distinguished from the video 710.

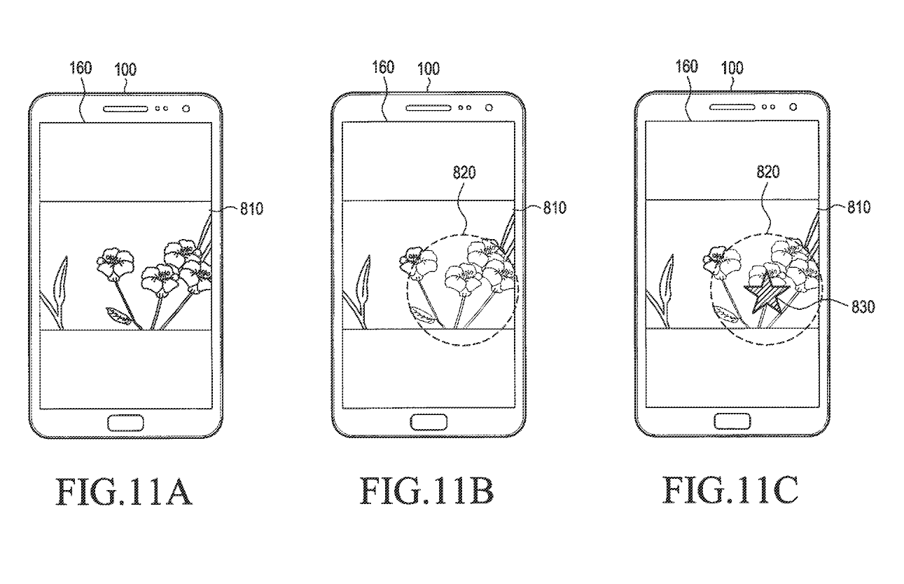

FIGS. 11A to 11C are screen views illustrating a method of overlappingly displaying the visual object on the video according to another embodiment of the present invention, where the visual object corresponding to an image in a star shape is displayed on the video.

Referring to FIG. 11A, a video 810 is reproduced.

Referring to FIG. 11B, the controller 170 detects attributes of the visual object to be overlappingly displayed on the video 810 in a state where the video 810 is reproduced, determines a visual effect area 820 having a size and a position corresponding to a size and a position of the visual object, and applies a blur effect to the visual effect area 820.

Referring to FIG. 11C, the controller 170 displays a visual object 830 corresponding to an image in a star shape in the visual effect area 820 to which the blur effect has been applied.

The controller 170 may detect a time point when the visual object 830 is displayed during the reproduction of the video 810 and provide the visual effect at the detected time point when the visual object 830 is displayed or a time point before or after a time interval preset at the detected time point.

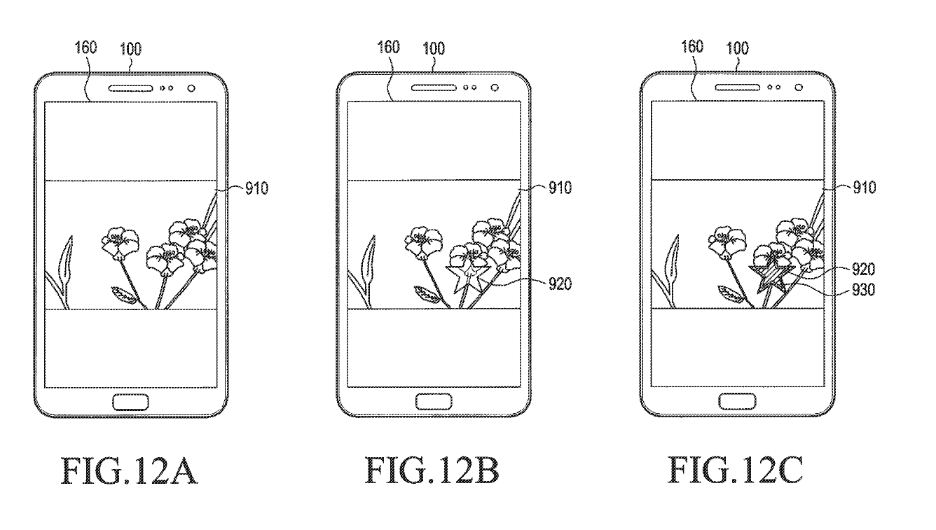

FIGS. 12A to 12C are screen views illustrating a method of overlappingly displaying the visual object on the video according to another embodiment of the present disclosure invention, where the visual object corresponding to an image in a star shape is displayed in the video.

Referring to FIG. 12A, a video 910 is reproduced.

Referring to FIG. 12B, the controller 170 detects attributes of the visual object to be overlappingly displayed on the video 910 in a state where the video 910 is reproduced, determines a visual effect area 920 having a size, a shape, and a position corresponding to a size, a shape, and a position of the visual object, and applies a dimming effect to the visual effect area 920. The controller 170 determines the visual effect area 920 having a shape expanded from the visual object, and the visual effect area 920 is processed to be darker than parts around the visual effect area 920 of the video according to the dimming effect.

Referring to FIG. 12C, the controller 170 displays a visual object 930 corresponding to an image in a star shape in the visual effect area 920 to which the blur effect has been applied. Since a center position of the visual effect area 920 is the same as a center position of the visual object 920 and the visual effect area 920 has a shape expanded from the visual object 930, edge parts of the visual effect area 920 are displayed on outer sides of the visual object 930.

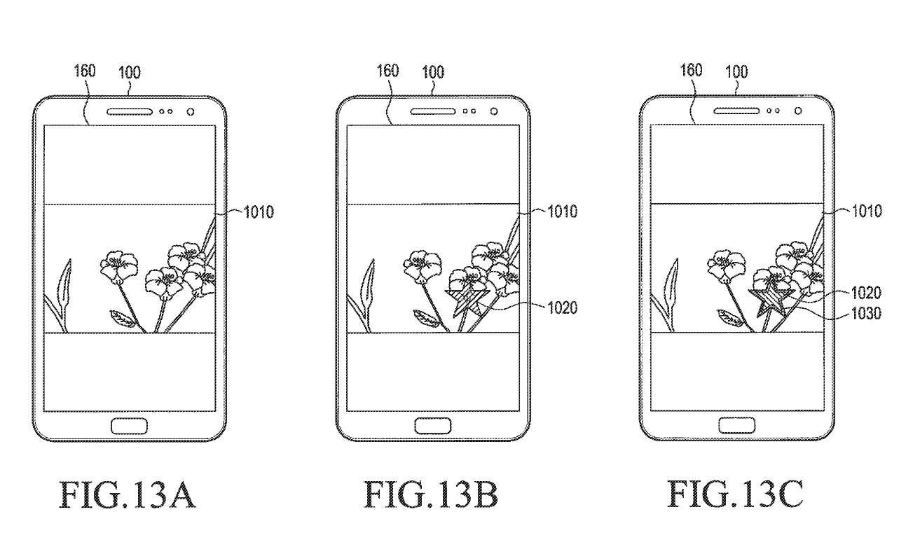

FIGS. 13A to 13C are views illustrating a method of overlappingly displaying the visual object on the video according to another embodiment of the present invention, where the visual object corresponding to an image in a start shape is displayed on the video.

Referring to FIG. 13A, a video 1010 is reproduced.

Referring to FIG. 13B, the controller 170 detects attributes of the visual object to be overlappingly displayed on the video in a state where the video 1010 is reproduced, determines a visual effect area 1020 having a size, a shape, and a position corresponding to a size, a shape, and a position of the visual object, and applies a subtrack effect to the visual effect area 1020. The controller 170 determines the visual effect area 1020 having a shape expanded from the visual object and a color of the visual effect area 1020 is processed to be a complementary color (for example, purple) of a color (for example, green) of the visual object according to the subtrack effect.

Referring to FIG. 13C, the controller 170 displays a visual object 1030 corresponding to an image in a star shape in the visual effect area 1030 to which the subtrack effect has been applied. Since a center position of the visual effect area 1020 is the same as a center position of the visual object 1020 and the visual effect area 1020 has a shape expanded from the visual object 1030, edge parts of the visual effect area 1020 are displayed on outer sides of the visual object 1030.

According to various embodiments of the present invention, while the video is reproduced, attributes of the visual object, such as a text, an image or the like, to be overlappingly displayed on the video are recognized and attributes of the video are controlled according to the attributes of the visual object, so that the visual object is distinguished from the video and thus visibility of the visual object and design esthetics are improved.

According to various embodiments of the present invention, the visual effect for easily distinguishing the visual object is applied to one part of the video in consideration of a position and a size of the visual object, and thus calculations of the controller and resources such as memory space of the storage unit are minimally used. As a result, there is no inconvenience in viewing the video through a partial visual effect.

It may be appreciated that the embodiments of the present invention can be implemented in software, hardware, or a combination thereof. For example, in the electronic device as illustrated in FIG. 1, components such as the storage unit, the communication unit, and the controller may be implemented as devices, respectively. Any such software may be stored, for example, in a volatile or non-volatile storage device such as a Read Only Memory (ROM), a memory such as a Random Access Memory (RAM), a memory chip, a memory device, or a memory Integrated Circuit (IC), or a machine (for example, computer)-readable storage medium optically or magnetically recordable such as a Compact Disc (CD), a Digital Versatile Disc (DVD), a magnetic disk, or a magnetic tape, regardless of its ability to be erased or its ability to be re-recorded. It is appreciated that the storage unit included in the electronic device is one example of a machine-readable storage medium suitable for storing a program or programs including commands for implementing various embodiments of the present invention. Therefore, embodiments of the present invention provide a program including codes for implementing a device or a method claimed in any claim of the appended claims and a machine-readable device for storing such a program. Moreover, such a program may be electronically transferred through an arbitrary medium such as a communication signal transferred through a wired or wireless connection, and the present invention properly includes the equivalents thereof.

Further, the electronic device may receive the program from a program providing apparatus connected to the electronic device wirelessly or by wire and store the received program. The program providing apparatus may include a memory for storing a program containing instructions for allowing the electronic device to perform the method of overlappingly displaying the visual object on the preset video and information required for the method of overlappingly displaying the visual object on the video, a communication unit for performing wired or wireless communication with the electronic device, and a controller for transmitting the corresponding program to the electronic device according to a request of the electronic device or automatically.

Although specific embodiments have been discussed in the above description, various modifications can be made without departing from the scope of the present invention. Accordingly, the scope of the present invention should not be determined by the above-described embodiments, but should be determined by the claims and the equivalents thereof.

What is claimed is:

1. A method of overlappingly displaying a visual object on a video, the method comprising:
setting a visual effect area at one part of the video;
applying a visual effect to the visual effect area; and
displaying a visual object such that the visual object overlaps the visual effect area to which the visual effect has been applied.

2. The method of claim 1, wherein the visual effect area is set based on information on an area of the video where the visual object is to be overlappingly displayed.

3. The method of claim 1, wherein the visual effect is set in advance or set based on an attribute of the visual object.

4. The method of claim 1, wherein the visual effect is directly applied to the video.

5. The method of claim 1, wherein the visual effect is applied to the video through a filter.

6. The method of claim 1, further comprising:
identifying an attribute of the visual object; and
determining an attribute of the visual effect area.

7. The method of claim 6, wherein each of the attribute of the visual object and the attribute of the visual effect area includes a size and a position.

8. The method of claim 7, further comprising determining whether there is a visual object to be overlappingly displayed on the video.

9. The method of claim 1, wherein the visual effect includes a blur effect, a dimming effect, or a subtrack effect.

10. The method of claim 1, wherein the visual effect area is larger than the visual object so that an entirety of the visual object fully overlaps the visual effect area.

11. The method of claim 10, wherein the visual effect area has a shape expanded from the visual object.

12. The method of claim 1, wherein the visual object corresponds to a text or an image.

13. A non-transitory machine-readable storage medium having a program recorded thereon for performing a method of overlapping displaying a visual object on a video, the method comprising:
setting a visual effect area at one part of the video;
applying a visual effect to the visual effect area; and
displaying a visual object such that the visual object overlaps the visual effect area to which the visual effect has been applied.

14. An electronic device comprising:
a display unit that displays a video; and
a controller that sets a visual effect area at one part of the video, applies a visual effect to the visual effect area through the display unit, and displays a visual object such that the visual object overlaps the visual effect area to which the visual effect has been applied.

15. The electronic device of claim 14, wherein the controller identifies an attribute of the visual object and determines an attribute of the visual effect area.

16. The electronic device of claim 15, wherein each of the attribute of the visual object and the attribute of the visual effect area includes a size and a position.

17. The electronic device of claim 14, wherein the visual effect includes a blur effect, a dimming effect, or a subtrack effect.

18. The electronic device of claim 14, wherein the visual effect area is larger than the visual object so that an entirety of the visual object fully overlaps the visual effect area.

19. The electronic device of claim 18, wherein the visual effect area has a shape expanded from the visual object.
